(19) United States
(12) Patent Application Publication
(10) Pub. No.: US 2002/0133821 A1
(43) Pub. Date: Sep. 19, 2002

(54) Activity schedule controls personalized electronic content guide

(75) Inventor: Yevgeniy Eugene Shteyn, Cupertino, CA (US)

Correspondence Address: Corporate Patent Counsel, U.S. Philips Corporation, 580 White Plains Road, Tarrytown, NY, 10591, US

(73) Assignee: KONINKLIJKE PHILIPS ELECTRONICS N.V.

(21) Appl. No.: 09/802,618

(22) Filed: Mar. 8, 2001

(51) Int. Cl. G06F 3/00; H04N 5/445; G06F 13/00

(52) U.S. Cl. 725/46; 725/39

(57) ABSTRACT

Electronic content information and the time slots for play-out are being determined based on the activities scheduled in the user's electronic calendar and the user's profile or declared interests. In this manner, the recording and downloading of content is automated based on the user's life style.

### FIELD OF THE INVENTION

The invention relates in particular to the processing and scheduling of electronic content information on a home network or home entertainment equipment.

### BACKGROUND ART

A conventional electronic program guide (EPG) provides the user with an on-screen listing of TV programs scheduled for broadcast on the channels that the user can tune into. Such EPG's for television systems are known in the art, particularly with regard to cable and satellite television systems. See, for example, U.S. Pat. No. 5,666,645; U.S. Pat. No. 5,751,282; U.S. Pat. No. 6,005,631, all incorporated herein by reference. An EPG is provided by a service provider, referred to EPG distributor. For example, the EPG data is converted into a video signal at the head end and transmitted to the user's TV set via, e.g., a dedicated channel, in SI (system information) data, via an OOB (out-of-band) channel or via an Internet connection. In another example, an EPG is made available through a server via a data network. The PTV 100 Personal TV Receiver, a joint effort of Philips Electronics and TiVo, is a hard-disk-drive (HDD) based video recorder for TV programs that requires the use of a phone connection to receive daily programming guide updates from a remote server. Based on the EPG the user can select what to watch and what to record on, e.g., the HDD.

U.S. Ser. No. 09/568,932 (attorney docket US 000106) filed May. 11, 2000 for Eugene Shteyn and Rudy Roth for ELECTRONIC CONTENT GUIDE RENDERS CONTENT RESOURCES TRANSPARENT, incorporated herein by reference, relates to a data management system that combines the data of an EPG with other data for other types of content information, typically within the context of a home entertainment system. The system comprises a data base for representing schedule information associated with scheduled content information from a content provider such as a broadcasting station or a video-on-demand (VOD) service. In addition, the data base also represents inventory information that is associated with content information available from another resource, e.g., as recorded at the consumer's digital Personal TV Receiver during previous broadcasts, or from a CD or DVD jukebox. Accordingly, this system introduces a general type of guide, herein after referred to as an electronic content guide (ECG). In an even more general aspect, the system provides a data management system for a home network with multiple resources. The system stores respective data descriptive of respective content information available from a respective one of the multiple resources on the network. The system combines the respective data in a single menu so that the user can select from the content information available. The multiple resources comprise, for example, a receiver for receiving first content information from external to the home network and a play-out apparatus for playing out second content information that is locally available in pre-recorded format. In addition, the menu can also represent content information available at a Web site with a specific URL, or available as email content information, as electronic advertisements, or as video games. By means of presenting the aggregate available content information regardless of its resource, the consumer is provided with a much wider range of options than conventional EPG's can provide, if only for the fact that these do not offer the content information recorded by or local to the individual consumer in a single menu. The term “local” can be interpreted as including recording sites to which a specific individual consumer has access, e.g., as having access to a LAN, an electronic library, or as a favor or owing to social relationships, see, e.g., U.S. Ser. No. 09/283,545 (attorney docket PHA 23,633) filed Apr. 1, 1999 for Eugene Shteyn for TIME- AND LOCATION-DRIVEN PERSONALIZED TV, herein incorporated by reference. This document discusses a server system that enables a subscriber to select a specific broadcast program for recording and a specific location and time frame for play-out of the recorded program.

### SUMMARY OF THE INVENTION

Aforementioned U.S. Ser. No. 09/568,932 (attorney docket US 000106) expands the concept of an EPG by integrating into a single access system (e.g., a GUI) electronic content information available from all suitable resources to which the user has access via his/her home network system, including the conventional EPG. These resources include, e.g., TV and radio broadcast stations, cable services, video-on-demand services, the Internet, but also resources on the user's home network such as a DVD jukebox, a HDD recorder, a VCR, etc. Accordingly, an ECG combines an EPG with data representative of an inventory of other content and represents them in a suitable GUI. The ECG thus renders content information less device-centric and more user-centric. The current invention emphasizes the role of the user even more. To this end, the invention provides a system, a method and software to control the EPG and/or ECG through the user's personal schedule, e.g., as represented on the user's electronic organizer with the user's scheduled personal activities. The invention provides a data processing system for managing electronic content information under control of data representative of at least one activity scheduled in a user's calendar. The system preferably has a control output for control of a data recording device for recording the electronic content. The system also preferably has an input for receiving input data representative of an EPG, and an input for receipt of the data representative of the activity. The latter is then used for data communication between the system and an electronic calendar on, e.g., the user's PDA. The managing may comprise selecting specific content information based on a profile of the user. The profile comprises, for example, a preference regarding an attribute (e.g., genre, semantic content, performer, etc.) of the content information based on which the user ordinarily decides whether or not to watch or listen to it. The profile may also comprise relative priorities of the activities scheduled in the calendar with respect to each other and/or with respect to certain content information, or relative priorities of content information entities or files. The profile gives further criteria, in addition to the calendar, based on which the system processes, e.g., records or not, content information. The system preferably creates a GUI for presenting an overview of the specific content information available in the time slots other than those associated with the scheduled activities in the calendar. The system preferably dynamically adjusts the processing upon a user interaction with the calendar. For example, if the user enters a new activity into the calendar or cancels a scheduled one, the availability changes of the time slots that can be used for processing or playing out content information. Based on, e.g., the user's profile, the system may allocate new time slots to suitable content or time-shift the content to a new time slot fitting into the profile of the user. e specific content information available in a further time slot other than the time slot in the calendar.

A known EPG presents to the user a grid with available TV programs per channel and per time slot. The user has to make a selection as to what to watch, when, and what to cache on a HDD for later play-out, by interacting with the EPG. The inventor now proposes that the EPG/ECG be used as an activity resource to fill available time slots in the user's personal schedule (in the user's calendar). Looked at it from another perspective, the activities scheduled in the user's calendar determine the remaining time slots that may be used for watching TV programs or pre-recorded video content information. The system selects content, e.g., for being recorded, so as to be available in the desired one of the remaining time slots. Preferably, the user's profile with respect to preferences regarding electronic content, content delivery options, presentation options and compression options optimize the content selection. As a result a new organization of the available content is made based on the time-slots that the user has not reserved for activities other than watching or listening to content information. Also, by means of the calendar and his/her profile, the user is enabled to automatically determine what to watch or listen to, with what quality of-service, when, and also where to play-out.

As to the compression options mentioned above, a certain degree of time-compression of recorded content information may be desirable to have content, matching the user's profile, fitting into a too small time slot. For example, a specific movie recorded on an HDD-based video recorder lasts one hour and 10 minutes, whereas the user has reserved only one hour for him/herself. The play-out can be done at a slightly higher uniform speed for the total length of the movie so as to have it fit into the reserved time slot. Techniques are known to reduce or avoid distortion of video or audio (higher pitch). Selective parts of the content can be played out at a higher speed than other parts to achieve the same result, namely fitting within the reserved time slot. Within this context, reference is made to U.S. Ser. No. 09/585,825 (attorney docket US 000123) filed Jun. 1, 2000 for Eugene Shteyn for CONTENT WITH BOOKMARKS OBTAINED FROM AN AUDIENCE'S APPRECIATION, incorporated herein by reference. This patent document relates to annotated content information, e.g., through markers that indicate those parts or scenes of the content that are expected to draw more attention from the audience than others. Speed can be controlled so as to play out the more interesting parts at the normal rate, and the less interesting parts at a more higher rate so as to selectively time-compress the content's being played out. Alternatively, only the highlights or interesting scenes can be chosen for play-out in the time slot indicated.

The user is also enabled to schedule a periodic presentation of content information, as it fits the aforementioned selection criteria and the general schedule. Manual drag-and-drop options to visualize the type of task/content in the activity guide's graphical user interface (GUI) can be added to increase the user-friendliness of the activity-controlled ECG even further. The user's scheduling action serves as a direct instruction to the rest of the system to make the content available at the designated time.

An implementation of the invention requires multiple devices to interoperate under software control (applications, scripts, etc.). The integration of devices in a home network environment is becoming increasingly more common. The HAVi architecture, the Home API initiative and UPnP, the Universal Serial Bus (USB), HomeRF Lite, and the Bluetooth standard, each involving substantial contributions from Philips Electronics, the Jini technology of Sun Microsystems, Inc., and others, have been developed to enhance the interoperability of multiple devices in a network. Via these control networks, or via point-to-point communications between devices, a user can access a variety of information and entertainment sources in a convenient manner.

Preferably, the calendar-driven ECG is dynamically updated when the user enters a new activity in calendar. For example, a time slot previously open for watching a movie or the news as recorded, is now allocated to, e.g., going to a concert with the family. As a result, the system reschedules the play out of the movie, and substitutes a more up-to-date news program for the one recorded, given the next time slots available for playing out the movie and the recorded news.

### BRIEF DESCRIPTION OF THE DRAWING

The invention is further explained below, by way of example and with reference to the accompanying drawing, wherein:

FIG. 1 is a block diagram of system in the invention;

FIG. 2 gives an example of a GUI to present the integrated activity—content information planning.

### DETAILED EMBODIMENTS

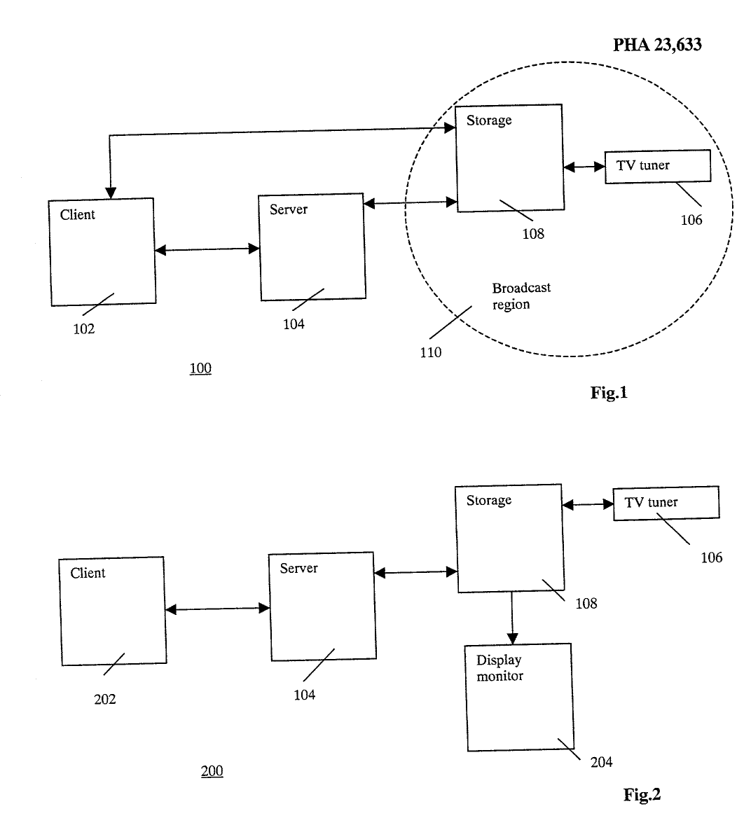

FIG. 1 is a block diagram of a data processing system 100 in the invention. System 100 manages electronic content information for a specific user. System 100 comprises a data processing sub-system 102 that receives as input: information 104 about a schedule of the user's personal activities; an electronic program guide EPG 106 received from a service provider via a data network, e.g., the Internet; information 108 about electronic content information available to this user, e.g., as stored on the user's home network or on a remote server; and information 110 about the user's preferences and/or priorities.

The user schedules personal activities in advance. These activities include, for example, an appointment with a doctor; picking up the children from school; preparing a dinner for visiting friends; bringing the car to the shop for a scheduled maintenance; helping a friend building a shed; attending a concert; work in the office/plant/lab; having a business meeting; making an overseas business trip; etc. The activities can be arranged, e.g., by topic, date and time slot when entered into system 100. The data representative of the user's activities can, for example, be downloaded from the user's PDA (not shown) into system 100 for local processing, or can be entered into sub-system 102 in another manner, e.g., manually through a suitable user-input device, etc. Within this context, reference is made to U.S. Ser. No. 09/464,866 (attorney docket PHA 23,884) filed Dec. 16, 1999 for Rik Sagar for SHARED ADDRESS-DATA SERVICE FOR PERSONAL CE EQUIPMENT. This document, incorporated herein by reference, relates to a method of transferring or enabling to transfer information in a first database of a first electronic apparatus to a second apparatus. The information is for operational use of both first and second apparatus. According to this method the information is uploaded from the first apparatus to a server, preferably via the Internet. The uploaded information is manipulated at the server. The manipulation comprises, for example, filtering and format conversion. The manipulated information is downloaded from the server, e.g., via the Internet, to the second apparatus for storage in a second data base of the second apparatus. If the information in the first database file is encoded in a proprietary format, the file format is to be converted into a useful intermediate format that allows the data to be easily manipulated by the server. This might typically be the comma-separated-variable (CSV) format, which is often used to pass data between databases that do not use a common file format. Accordingly, the personal activities data can easily be transferred so as to be processed within system 100 as further explained below.

Conventional EPG's are known. EPG 106 provides an overview in a GUI of programs per channel and per time slot. This overview can be combined with the meta-data 108 about content information other than that referred to in the EPG in order to create an electronic content guide (ECG), e.g., as discussed in U.S. Ser. No. 09/568,932 (attorney docket US 000106), incorporated herein by reference. This other content information comprises, e.g., content stored locally on the user's home network on a HDD or in a DVD or CD jukebox, etc., or at a remote server, content which is available from a video-on-demand service via cable or the Internet, etc. The EPG data 106 and the data 108 are provided to processor 102 in a suitable format, after transcoding if necessary.

Data 110 represents the preferences and priorities of the user. For example, data 110 comprises information about the types (genres) of movies or actors that this specific user particularly likes, the kind of sports matches and teams or players involved that this user, whether he/she would like to watch the news channel and the weather channel at particular times, etc. Data 110 also comprises, in this example, the (relative) priorities that this user has set to particular activities and/or content information. For example, activities scheduled by the user in his PDA are always more important than any TV program unless the program is an ice hockey match involving the San Jose Sharks, in which case the user wants to be alerted of the upcoming event so as to be able to reschedule his/her activities. As another example, this specific user would like to have multiple alternatives listed, if there are any for a particular time slot, so that he/she can make a choice or zap through them.

Processing sub-system 102 runs a software application 112 that prepares a schedule for the user, e.g., for use on, or retrieval by, a personal digital assistant (PDA) or a set-top box (STB). The schedule preferably integrates within a single overview 114 the user's planned activities as specified by data 104 from the user's activity calendar, as well as the electronic content information scheduled to be made (conditionally) available in the remaining time slots. Alternatively, the schedule only presents per available time-slot, i.e., not already reserved for other activities, one or more descriptions or other indicators of content information that matches the user's profile and preferences. In this example, the activities' schedule 104 and the user's profile 110 serve as selection criteria to determine the selection from content information 106 and 108 for scheduled play-out, recording, or stand-by for play-out, etc., on a home network 116. Network 116 comprises, for example, an HDD-based recording apparatus 118, a TV receiver 120, an STB 122. Software application 112 enables to identify content information that matches the user's profile 110, the content information being currently available, from an outside source such as a TV broadcast station, cable provider, stored on home network 116, or scheduled to be available in the near future, e.g., according to EPG 106. The expression “near future” is used herein to indicate a time scale on which it makes sense to the user, given the time range of his/her scheduled activities, to verify whether or not the content matches profile 110.

Software application 112 controls home network 116 via a control component 124. Component 124 may be a functional part of, e.g., processing sub-system 102, a part of software application 112, a part of home network 116, etc. Component 124 controls network 116 to prepare content information for play-out or for being stand-by, as identified by application 112.

Component 124 controls network 116 in order to, e.g., record the proper broadcasts on HDD 118 or another storage medium (not shown), to retrieve the proper content information stored at other resources within (e.g., a DVD carousel) or outside (e.g., storage space leased on a remote server) home network 116, etc. For example, a movie matching the user's profile may be downloaded in advance over a data network such as the Internet. This sees to it that the download is complete or has advanced to such as state that the retrieval does not interfere with the scheduled play-out.

Processing system 102 and/or parts 104-110, 114 and 124 can be incorporated in, e.g., STB 122 or a PC. Alternatively, processing system 102 is accommodated at a remote server connected to the user's home network via the Internet or another data network. The service provider receives from the user his/her preferences and relative priorities, and an indication of the relevant time slots not occupied by pre-scheduled activities. The service provider preferably also has access to an inventory of content information stored locally at network 116, and knowledge of the functionalities of the user's home entertainment system, e.g., what is there for data recording (e.g., HDD, VCR, PC) and play-out (TV display monitor, PC display monitor, surround sound audio system, DVD player, etc). Based on this information, the service provider generates an ECG of content information matching the user's profile for play-out in the relevant time slots not occupied by other activities of the user. The play out could, e.g., be fully automated and scheduled to be played out via a script or, alternatively, be initiated by the user interacting with the ECG via a suitable GUI. The configuration of this profile-matched and activity-based ECG can be delegated to a server as discussed in U.S. Ser. No. 09/519,546 (attorney docket US 000014) filed Mar. 6, 2000, for Erik Ekkel et al., for PERSONALIZING CE EQUIPMENT CONFIGURATION AT SERVER VIA WEB-ENABLED DEVICE, incorporated herein by reference. The profiling of the user with regard to his/her content information preferences can be carried out, or fine-tuned, dynamically, e.g., by logging the TV programs he/she has tuned into, as indicated by arrow 126.

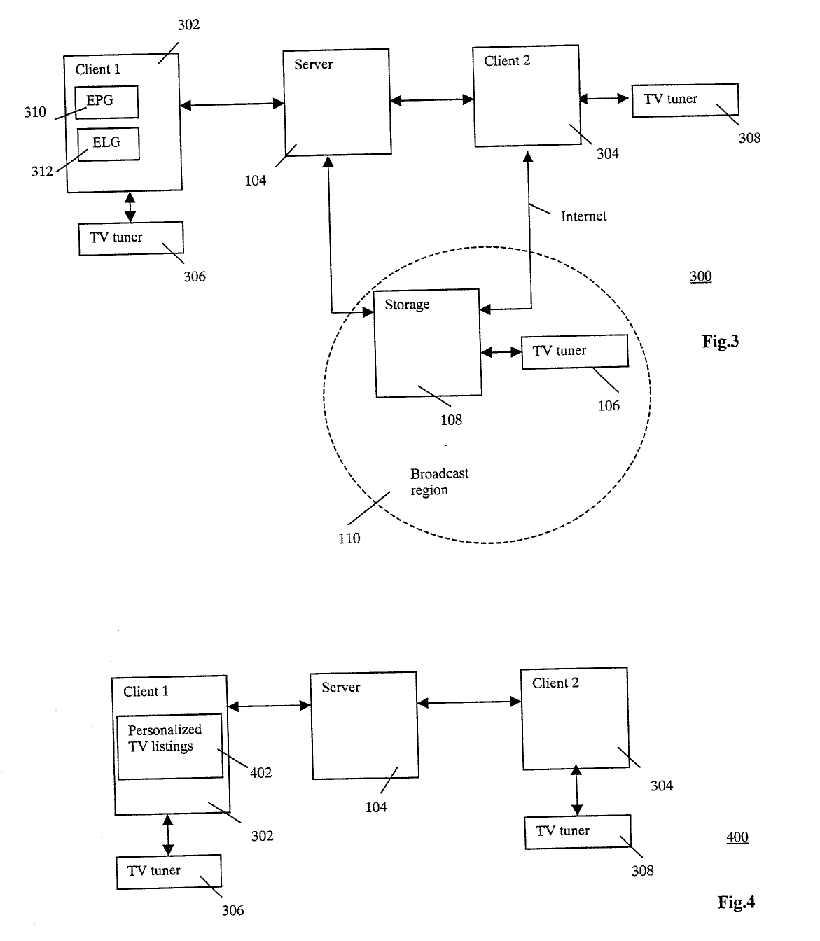

FIG. 2 gives an example of the appearance of a GUI 200 for an ECG based on the activity schedule and preferences of a specific user. As explained above, the user's calendar serves as a filter to determine the time slots for playing out content information, including watching a live broadcast, locally recorded content, locally available content and streaming content over the Internet. In this example, GUI 200 lists the time slots specified for Tuesday March 6. Time slot 6:30-7:30 pm is reserved for playing out classical music, when this specific user is having dinner with his family. This playing out is implemented by, e.g., having the radio automatically tuned to a station broadcasting classical music or by starting a CD player, and by having the music being played out by the loudspeakers in the dining room. The radio, the CD player and the loudspeakers are part of the user's home network. Time slot 7:30-8:00 pm is reserved for checking the children's homework and content information is explicitly not processed by the home network. Time slot 8:00-10:00 pm is not covered by content information play-out for the user, as he has reserved this Tuesday evening to help his friend down the street with a plumbing job on a vintage automobile that is being restored. Time slot 10:00-10:30 pm is reserved for news, sports review, and weather information. Time slot 10:30-12:00 pm is reserved for playing out a movie according to this user's preferences. GUI 200 lists alternative options currently availabe, e.g., in a drop down menu 202, some of which may be recorded, others may be being broadcast at that time. As to the recordings, these may be available on, e.g., a HDD recording device that got controlled to record the information as it matches a profile of interest of this user. Also, the recordings can be available on DVDs purchased by the user or obtained from the local library. Data about these DVD's can be entered into, and deleted from, system 100, e.g., manually by the user or automatically when the user stores the DVD into a carousel for later play-out or removes it therefrom. The home network can be configured to implement this keeping-up-to-date of the inventory using, e.g., UPnP. In the end, the user does not have to tune to the proper channel or activate the proper equipment. He only has to interact with the GUI and select the preferred one of the alternatives listed.

What is claimed is:

1. A data processing system for managing electronic content information under control of data representative of at least one activity scheduled in a user's calendar.

2. The system of claim 1, comprising a control output for control of a data recording device for recording the electronic content.

3. The system of claim 1, having an input for receiving input data representative of an EPG.

4. The system of claim 1, having an input for receipt of the data representative of the activity.

5. The system of claim 1, wherein the managing comprises selecting specific content information based on a profile of the user.

6. The system of claim 5, wherein the profile comprises at least one of the following:
a preference regarding an attribute of the content information; and
a relative priority of the activity.

7. The system of claim 5, wherein the managing comprises recording the specific content information.

8. The system of claim 5, wherein the managing comprises creating a GUI for presenting an overview of the specific content information available in a first time slot other than a second time slot associated with the scheduled activity.

9. The system of claim 1, wherein the system dynamically adjusts the processing upon a user interaction with the calendar.

10. A method of enabling to manage a processing of electronic content information for an end-user, the method comprising controlling the processing based on availability of a time slot in a calendar of the end-user.

11. The method of claim 10, wherein the processing comprises recording the electronic content.

12. The method of claim 10, comprising processing the electronic content depending on an EPG.

13. The method of claim 10, comprising receiving data representative of the availability of the time slot.

14. The method of claim 10, wherein the managing comprises selecting specific content information based on a profile of the user.

15. The method of claim 14, wherein the profile comprises at least one of the following:
a preference regarding an attribute of the content information; and
a relative priority of an activity scheduled in the calendar.

16. The method of claim 14, wherein the managing comprises creating a GUI for presenting an overview of the specific content information available in a further time slot other than the time slot in the calendar.

17. The method of claim 10, comprising dynamically adjusting the processing upon a user interaction with the calendar.

18. Software for enabling an end-user to manage a processing of electronic content information, the software controlling the processing based on data representative of a calendar of the end-user.

19. The software of claim 18, wherein the processing comprises selectively recording the content information.

20. The software of claim 19, wherein the processing comprises playing out at least part of the recorded content information so as to have the played out content information substantially fitting within an available time slot.

21. The software of claim 18, for control of generating a GUI for presenting an overview of specific content information available in a time slot in harmony with the calendar.
